(19) United States
(12) Patent Application Publication
(10) Pub. No.: US 2011/0054972 A1
(43) Pub. Date: Mar. 3, 2011

(54) CALCULATION/DETERMINATION OF BUDGET AND EMPLOYEE ALLOCATION TARGETS USING A MODEL

(75) Inventors: Ty Hayden, Grand Junction, CO (US); Sanej Chandrasenan Nair, Belmont, CA (US); Michele Chung, San Jose, CA (US)

(73) Assignee: Oracle International Corporation, Redwood Shores, CA (US)

(21) Appl. No.: 12/549,690

(22) Filed: Aug. 28, 2009

(51) Int. Cl. G06Q 10/00; G06F 3/048

(52) U.S. Cl. 705/8; 705/11; 705/10; 715/780

(57) ABSTRACT

In various embodiments, systems, methods, and user interfaces are provided for calculating and/or determining budget and employee allocation targets using a model. In one example, users can create a model by selecting an allocation method and a set of allocation criteria. Allocation criteria can be organized into a table or interactive matrix that enables the user to interact with the model and preview application of the model to a budget or target. Users can enter values they want to model for employees who meet that criteria combination. In some embodiments, the first criterion is used to automatically create the broadest grouping and subsequent criteria creating subgroups within the larger group.

### BACKGROUND OF THE INVENTION

This disclosure relates to using systems, methods, and user interfaces for calculating and/or determining budget and employee allocation targets using a model.

Compensation software programs allow users, such as managers and other compensation professionals, to plan and allocate budgets and awards. These plans and allocations may take place on a global basis across multiple currencies. Some compensation programs enable users to distribute budgets and compensation based on guidelines, see a worksheet view of employees, their performance ratings, and total compensation. Compensation software programs can also allow users to promote employees and give them new performance ratings and rankings.

Compensation software programs often may not allow managers and compensation professionals to flexibly calculate target amounts and then apply those target amounts to either a line manager's budget sheet or a worksheet on which employee allocations were made. Target amounts are often configured by a compensation administrator during initial plan setup, for example, using a standard rate. This means that a target rate is usually calculated when the participation process is run. Therefore, target amounts are not generally determined or modified by line managers during a compensation period.

In addition, these prior compensation packages can require compensation administrators to define separate profiles, such as separate variable rate profiles, for each set of criteria used to vary a target rate. For example, if target rates varied by a person's work location and job, for every combination of the different work locations and different jobs, a variable rate profile may need to be created and the corresponding target amount or percentage entered. This process can be very time consuming, in addition to being prone to data-entry error.

Accordingly, what is desired are improved methods and apparatus for solving some of the problems discussed above. Additionally, what is desired are improved methods and apparatus for reducing some of the drawbacks discussed above.

### BRIEF SUMMARY OF THE INVENTION

In various embodiments, systems, methods, and user interfaces are provided for calculating and/or determining budget and employee allocation targets using a model. In one example, users can create a model by selecting an allocation method and a set of allocation criteria. Allocation criteria can be organized into a table or interactive matrix that enables the user to interact with the model and preview application of the model to a budget or target. Users can enter values they want to model for employees who meet that criteria combination. In some embodiments, the first criterion is used to automatically create the broadest grouping and subsequent criteria creating subgroups within the larger group.

In one embodiment, upon completing a model, users can preview their model and select how they want to use the model. When modeling budgets, for example, users can choose to either use the model to (1) establish budget amounts or (2) establish budget targets. Additionally, in conjunction with a compensation program, users can choose to (1) establish employee compensation amounts or (2) establish employee targets.

Users can create multiple models for a plan. This allows users to select different allocation methods and criteria and see how the results differ. In addition, users can share models with other users, such as lower level managers or direct managers. This enables a higher-level manager to create target amounts and then pass these recommendations down to subordinate managers. Also, compensation professionals can create “global” models which are made available to all managers. Using a global model, a company can easily pass down target recommendations to managers.

Thus, using a model eliminates the need for users to have experience with plan design setup. One or more user interfaces can be provided to be user-friendly for use by all levels of users.

In various embodiments, a computer-implemented method for creating a compensation plan using a model can include generating a first graphical user interface. The first graphical user interface can be configured to allow a user to create compensation models. Information may be received via the first graphical user interface enabling a computer system to create a compensation model. The compensation model can include an allocation method determining the calculation to be used when the model is applied and a set of allocation criteria used to build an interactive matrix. The compensation model can be created or build based on the information received via the first graphical user interface. A second graphical user interface may be displayed that allows a user to interact with the matrix of the compensation model. The compensation model then may be previewed or applied to a budget or a target. Information may be generated representing of the budget or target with the applied model.

In further embodiments, information representing the allocation method may be received from a selection via the first graphical user interface of a predetermined allocation method. Information representing the set of allocation criteria may be received from a selection via the first graphical user interface of one or more predetermined allocation criteria. Information may be about employees that is related to the set of allocation criteria. The information may be used to build the matrix with the set of allocation criteria. A hierarchy may be determined based on the set of allocation criteria, and the matrix may be structured using the hierarchy.

A further understanding of the nature of and equivalents to the subject matter of this disclosure (as wells as any inherent or express advantages and improvements provided) should be realized by reference to the remaining portions of this disclosure, any accompanying drawings, and the claims in addition to the above section.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is a simplified illustration of a system that may incorporate an embodiment of the present invention;

FIG. 2 is a simplified flowchart of a method for determining a budget using a model in one embodiment according to the present invention;

FIG. 3 is an interactive matrix or table provided by a model in one embodiment according to the present invention;

FIG. 4 is an illustration of a graphical user interface configured to create models in one embodiment according to the present invention;

FIG. 5 is an illustration of a graphical user interface displaying an interactive matrix for a model in one embodiment according to the present invention;

FIG. 6 is table displaying structure of an interactive matrix for a model based on a selected allocation method in one embodiment according to the present invention;

FIG. 7 is an illustration of a graphical user interface for previewing a model in one embodiment according to the present invention;

FIG. 8 is an illustration of a graphical user interface displaying preview results of a model in one embodiment according to the present invention;

FIG. 9 is flowchart of the modeling functionality of the system of FIG. 1 in one embodiment according to the present invention; and

FIG. 10 is a simplified block diagram of a computer system that may be used to practice embodiments of the present invention.

### DETAILED DESCRIPTION OF THE INVENTION

In various embodiments, users of a compensation software package, such as managers and other compensation professionals, can create one or more models for compensating a workforce. A model may be created by selecting an allocation method and a set of one or more allocation criteria. In one example, allocation criteria may be organized with a first criterion creating the broadest grouping and subsequent criteria creating subgroups within the broadest grouping. Using an interactive matrix, users can enter supply values they want to model for employees who meet or otherwise satisfy the allocation criteria.

In some embodiments, upon completing a model, users can preview the model by selecting how to use the model. For example, when modeling budgets, users can choose to use the model to establish budget amounts or establish budget targets. When modeling compensation, users can choose to establish employee compensation amounts or establish employee targets. Accordingly, if users choose to apply the model as target amounts (either for budgets or allocations), modeled values can be allocated. Thus, users can choose whether to apply the modeled values or not as desired.

In further embodiments, users can create multiple models for a plan. This allows users to select different allocation methods and criteria and to determine how the results of each differ. In addition, managers or other compensation professionals can share models with others. This enables a higher-level manager, for example, to create target amounts and then pass these recommendations down to subordinate managers within the compensation software package. Also, managers or other compensation professionals can create “global” models which are made available to all users. Using a global model, a company can easily pass down target recommendations to all managers.

As a result, the flexible model reduces or otherwise eliminates the need for users to have intimate experience with compensation plan design setup. Thus, a user-friendly interface can be provided that is intended to be used by all levels of users.

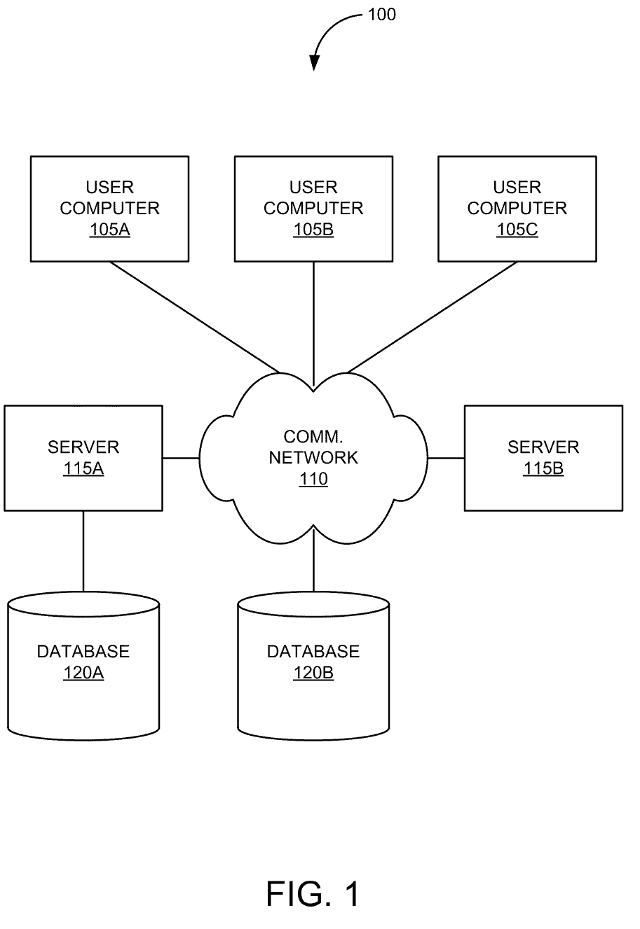

FIG. 1 is a simplified illustration of system 100 that may incorporate an embodiment of the present invention. FIG. 100 is merely illustrative of an embodiment incorporating the present invention and does not limit the scope of the invention as recited in the claims. One of ordinary skill in the art would recognize other variations, modifications, and alternatives.

In one embodiment, system 100 includes one or more user computers 105 (e.g., computers 105A, 105B, and 105C). User computers 105 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 105 can also have any of a variety of applications, including one or more applications configured to perform methods of the invention, as well as one or more office applications, database client and/or server applications, and web browser applications.

Alternatively, user computers 105 can be any other electronic device, such as a thin-client computer, Internet-enabled mobile telephone, and/or personal digital assistant, capable of communicating via a network (e.g., communications network 110 described below) and/or displaying and navigating web pages or other types of electronic documents. Although the exemplary system 100 is shown with three user computers, any number of user computers or devices can be supported.

Certain embodiments of the invention operate in a networked environment, which can include communications network 1 10. Communications network 110 can be any type of network familiar to those skilled in the art that can support data communications using any of a variety of commercially-available protocols, including without limitation TCP/IP, SNA, IPX, AppleTalk, and the like. Merely by way of example, communications network 110 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 115 (e.g., computers 115A and 115B). Each of server computers 115 may be configured with an operating system including without limitation any of those discussed above, as well as any commercially-available server operating systems. Each of server computers 115 may also be running one or more applications, which can be configured to provide services to one or more clients (e.g., user computers 105) and/or other servers (e.g., server computers 115).

Merely by way of example, one of server computers 115 may be a web server, which can be used, merely by way of example, to process requests for web pages or other electronic documents from user computers 105. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 105 to perform methods of the invention.

Server computers 115, in some embodiments, might include one ore more file and or/application servers, which can include one or more applications accessible by a client running on one or more of user computers 105 and/or other server computers 1 15. Merely by way of example, one or more of server computers 115 can be one or more general purpose computers capable of executing programs or scripts in response to user computers 105 and/or other server computers 115, including without limitation web applications (which might, in some cases, be configured to perform methods of the invention).

Merely by way of example, a web application can be implemented as one or more scripts or programs written in any programming language, such as Java, C, or C++, and/or any scripting language, such as Perl, Python, or TCL, as well as combinations of any programming/scripting languages. The application server(s) can also include database servers, including without limitation those commercially available from Oracle, Microsoft, IBM and the like, which can process requests from database clients running on one of user computers 105 and/or another of server computer 115.

In some embodiments, an application server can create web pages dynamically for displaying the information in accordance with embodiments of the invention. Data provided by an application server may be formatted as web pages (comprising HTML, XML, Javascript, AJAX, etc., for example) and/or may be forwarded to one of user computers 105 via a web server (as described above, for example). Similarly, a web server might receive web page requests and/or input data from one of user computers 105 and/or forward the web page requests and/or input data to an application server.

In accordance with further embodiments, one or more of server computers 115 can function as a file server and/or can include one or more of the files necessary to implement methods of the invention incorporated by an application running on one of user computers 105 and/or another of servers 115. Alternatively, as those skilled in the art will appreciate, a file server can include all necessary files, allowing such an application to be invoked remotely by one or more of user computers 105 and/or server computers 1 15. It should be noted that the functions described with respect to various servers herein (e.g., application server, database server, web server, file server, etc.) can be performed by a single server and/or a plurality of specialized servers, depending on implementation-specific needs and parameters.

In certain embodiments, system 100 can include one or more databases 120 (e.g., databases 120A and 120B). The location of the database(s) 120 is discretionary: merely by way of example, database 120A might reside on a storage medium local to (and/or resident in) server computer 115A (and/or one or more of user computers 105). Alternatively, database 120B can be remote from any or all of user computers 105 and server computers 115, so long as it can be in communication (e.g., via communications network 110) with one or more of these. In a particular set of embodiments, databases 120 can reside in a storage-area network (“SAN”) familiar to those skilled in the art. (Likewise, any necessary files for performing the functions attributed to user computers 105 and server computers 115 can be stored locally on the respective computer and/or remotely, as appropriate). In one set of embodiments, one or more of databases 120 can be a relational database that is adapted to store, update, and retrieve data in response to SQL-formatted commands. Databases 120 might be controlled and/or maintained by a database server, as described above, for example.

In various embodiments, system 100 can include one or more models representing a compensation pattern or compensation guidance tool. System 100 can include a budget modeling tool that enables users to design their own pattern on which budget amounts or targets can be determined. Each pattern can be built from an allocation method and selected allocation criteria.

In general, the models of system 100 make it easier for a user to determine budget amounts or budget targets based on different pay factors (e.g., eligible salary, comparatio, market midpoint, etc.) and allocation criteria (e.g., length of service, performance rating, location, etc.). Models also make it easy for users to see how budget amounts and targets vary when using different pay factors and employee criteria.

In one embodiment, system 100 includes a set of graphical user interfaces that enable a user to create a model to determine a budget or budget targets based on a specified percentage of eligible salaries or amount per employee. System 100 further can allow the the user to determine amounts by bringing employees up to a specified percentage of their grade range or quartile, or by bringing employees up to a specified quintile.

In various embodiments, system 100 enables a user to quickly determine budget amounts or budget targets using a model when they have many people to budget for or have complex budgeting requirements. Users can also use models to determine budget targets when doing employee-level budgeting.

Compensation managers can use models to help determine automatically issued budgets for organizations that do administrative budgeting. Therefore, no manager intervention is required in the budgeting process. Budget amounts can be predetermined and published to managers using system 100, who then can allocate compensation directly to eligible employees. In one example, a compensation manager may want to determine a budget where all line managers receive 8% of their employees' eligible salaries.

In another example, line managers using system 100 can also use models to determine budget amounts for direct and indirect reporting managers when using trickledown budgeting. Line managers may also use models to determine employee budgets when using the employee rollup budgeting method. For example, a VP may want to determine a budget that is enough to bring eligible employees who have worked in the U.S. for at least 1 year to the 4th quartile of their grade range. On the other hand, if budgeting at the employee-level, a line manager may want to distribute 100% of the target budget amount for employees whose last performance rating was “outstanding,” and 50% of the target amount for employees whose last performance rating was “average.”

In some embodiments, system 100 enables a user to create models that are plan specific. Once saved, the plan-specific models can be designated to be used and accessed solely within a given plan. In another example, models may be used within different plan periods for the same plan. Therefore, a model created in for an Annual Salary Plan in the 1-Jan.-2005 to 31-Dec.-2005 plan period, for example, may be used in subsequent periods for the same plan.

In further embodiments, system 100 may include access control lists and sharing features that enable a user to create a model that is available to be used by others. Doing so allows compensation managers or high-level line managers to create models that others can use as guidelines when determining their own budgets. In one example, system 100 can include 4 model access levels:

Private—Only the user who created the model can view and use it.

Public for direct reporting managers—Direct reporting managers of the user who created the model can view and use it.

Public for all lower level manager—Direct and indirect reporting managers of the user who created the model can view and use it.

Global—This access level is only available to compensation professionals. All line managers having view or full access to the corresponding plan may access this model.

In one example, the Public and Global Models cannot be changed by the non-owner, but can be easily duplicated. Therefore, any derivative copied versions can then be modified and used to create further models.

### Creating a Model

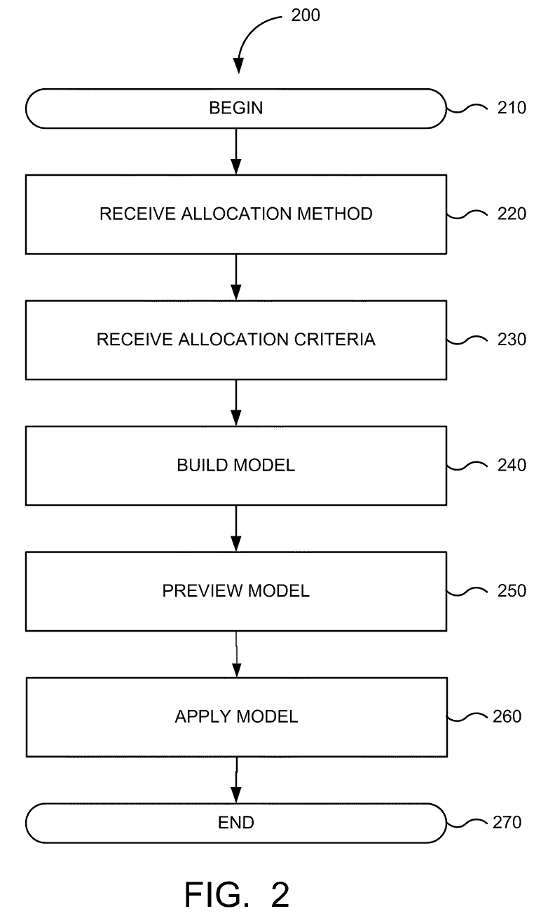

FIG. 2 is a simplified flowchart of method 200 for determining a budget using a model in one embodiment according to the present invention. The processing of method 200 depicted in FIG. 2 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 200 depicted in FIG. 2 begins in step 210.

In step 220, an allocation method is received. An allocation method can include information that enables system 100 to determine which calculation to use when applied to a particular scenario. For example, the allocation method determines what factor of employee pay the model uses and how to calculate amounts. System 100 may include a variety of allocation methods to give users flexibility in how they want to determine their budget or target amounts. Users can create multiple models using different allocation methods to see how each allocation method affects their budget or target.

In various embodiments, users select the allocation method when creating a model. System 100 may filter which allocation methods are available based on the type of plan being modeled. For example, non-salary plans may not include methods such as Grade Range, Comparatio, Quartile, or Quintile. Non-monetary plans (e.g., those without an eligible salary rate) may not include methods based on eligible salary.

Some allocation methods are as simple as, for example, funding the budget based on X percent of eligible salaries (where X is a user-entered amount), to some as complex as bringing all eligible employees up to X quartile of their grade range. System 100 may model amounts based on the selected allocation method and one or more of the following:

X Percent of Eligible Salaries

X Amount per Employee

X Percent of Target Amount

Up to X Percent in Target Range

Bring Employee up X Percent in Grade Range

Bring Employees up to X Percent of Grade Range

Bring Employees to Grade Minimum

Bring Employees up X Percent in Comparatio

Bring Employees up to Comparatio X

Bring Employees up X Quartiles

Bring Employees up to Quartile X

Bring Employees up X Quintiles

Bring Employees to Quintile X

Bring Employees to X percent of market midpoint

Bring Employees up X percent of market midpoint

Bring Employees up X percent in market range

Bring Employees up X percent of market range

Mass Adjustment by Percent

Mass Adjustment by Amount per Employee

Target Range (percent)

Target Range (amount)

X Percent of Another Worksheet Column

Supply a Text Value to X Column

In various embodiments, system 100 may provide a default allocation method for each new model. For example, when a user creates a new model, “X Percent of Eligible Salary” may be defaulted as the allocation method. In another example, system 100 may determine amounts by performing a mass adjustment based on a flat amount or a % of eligible salary. For example, a user may allocate workers in France an additional 100 Euros or an additional 1%.

In step 230, allocation criteria is received. Allocation criterion can include any principles, rules, standards, or other information that identify who or what to include in the model. For example, the allocation criteria may identify the employees to include in the model. Therefore, a user can select criteria such as job, location, performance rating, and years of service, among others. Some examples of allocation criteria are: Comparatio, Country, Grade, Grade Quartile, Job, Compensation Workbench Performance Rating, Appraisal Performance Rating, Department, Position, Years of Service, Direct Report, Flexfields, Custom Columns, Job Flexfields, Quintile, Grade Range Placement, Legal Employer, or the like.

In step 240, a model is built. In general, system 100 may organize the selected allocation criteria into a table or interactive matrix. System 100 may use the first criterion to create a broadest grouping. Thereafter, system 100 may use subsequent criteria create subgroups within the larger group. When more than 1 criterion is used, system 100 may automatically organize the criteria in a hierarchy.

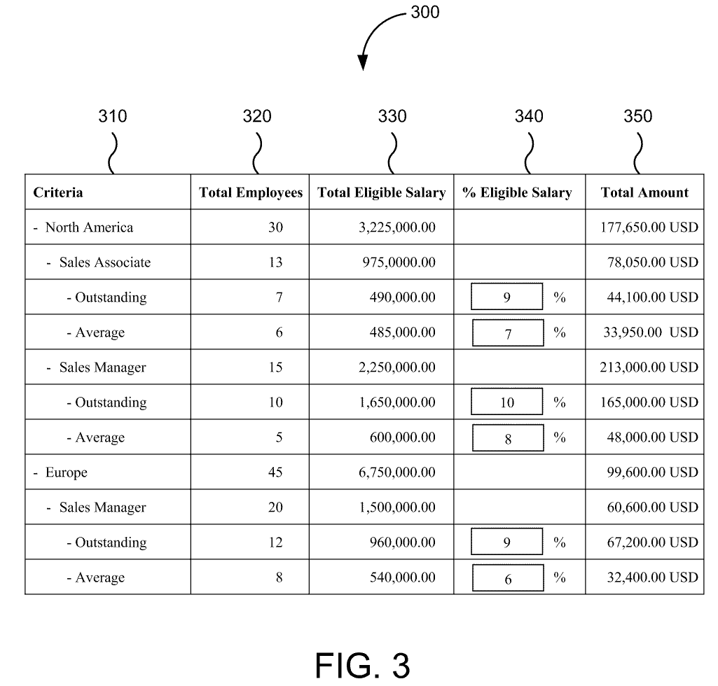

FIG. 3 is interactive matrix or table 300 provided by a model in one embodiment according to the present invention. In column 310, the model uses “% of Eligible Salary” as the allocation method, Location as the first criterion, Job as the second criterion, and Performance Rating as the third criterion. Table 300 displays the number of eligible employees who fall into each criteria combination in column 320 and their total eligible salaries in column 330. In column 340, an employee's “% Eligible Salary” is shown in an interactive field where the user enters the percentage of eligible salary (or an appropriate value based on the selected allocation method) to budget for each employee who meets the criteria. In column 350, table 300 displays the total amount of the budget based on the employees who meet that specific criteria combination.

In some embodiments, table 300 may include a summary table which provides totals of the user's budget such as the total number of eligible employees included in the calculations, total eligible salaries, amount allocated using this model, the user's budget, and unused budget.

Referring again to FIG. 2, in step 250, the model is previewed. Upon completing a model, users can preview their model and select how they want to use the model. When modeling budgets, for example, users can choose to either use the model to (1) establish budget amounts, or (2) establish budget targets. In some embodiments, users can choose to (1) establish employee compensation amounts, or (2) establish employee targets.

In step 260, the model is then applied. For example, if the user is happy with how his budget (or employee) amounts look based on the model preview, the system can apply the model. Method 200 of FIG. 2 ends in step 270.

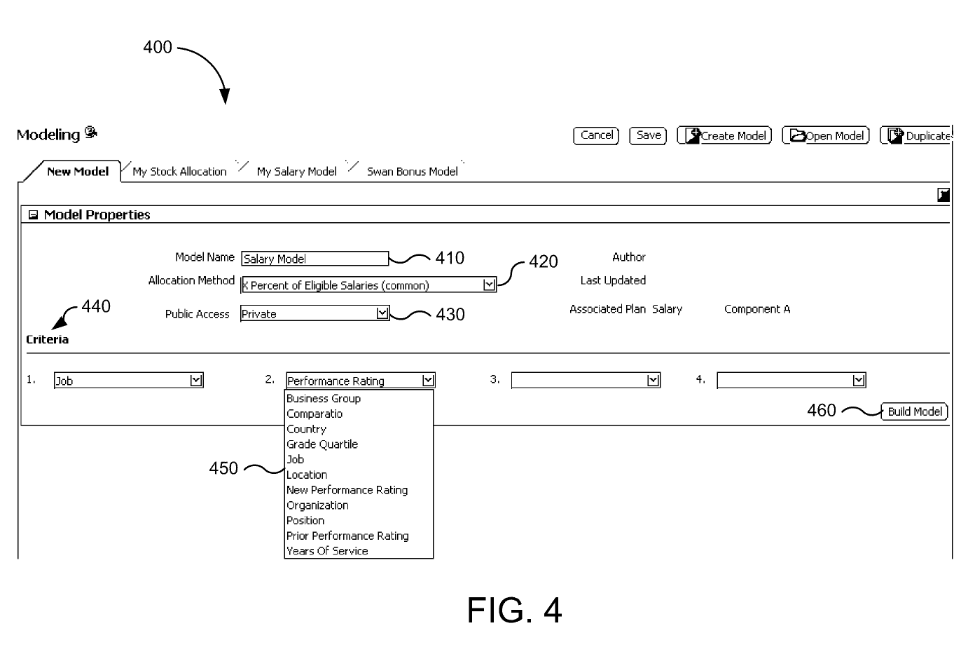

FIG. 4 is an illustration of graphical user interface (GUI) 400 configured to create models in one embodiment according to the present invention. GUI 400 may be generated by one or more computer systems and displayed on a display device associated with the one or more computer systems or on a display device associated with a different computer system. GUI 400 may incorporate elements or controls from graphical user interface toolkits, markup languages, or the like, and functionality from compiled programs, scripting languages, or the like.

In this example, GUI 400 may include one or more controls, such as “Create Model,” “Open Model,” “Duplicate Model,” or the like, for creating models. When creating a new model, duplicating a previously created model, or opening a previously created model, GUI 400 may display one or more controls or fields that accept user input or display properties and/or attributes of a model. A new model can be created from various graphical user interfaces, such as GUI 400, by (1) clicking the Create a model button from a Model Overview Page, (2) clicking the Create a Model option from a Budget Page, (3) clicking the Create a Model option from a worksheet, and (4) clicking the Create a Model button in a model page. The Model Button can offers two additional choices to the user, such as Open a model—Open a previously saved model, whether it is one created and saved by the user, or by a different author; or Apply a model to a budget—Apply a model to a budget thereby using the saved allocation method and criteria.

In one example, when the user creates a new model or selects one or more models to open, each model will appear on its own tab within the page. Thus, the user can easily toggle back and forth between models to compare how each model affects his budget. It will be apparent that eligibility for a plan determines whether a person is included in the employee or workforce population selected for a budget and hence, a model. Although this document may use the word “employee”, contingent workers and others may also be included in a model (and budget).

In various embodiments, GUI 400 may include a model properties region. Within the model properties region, the user can enter properties or attributes of the model, such as model name, allocation Method, public access controls, a set of allocation criteria, or the like. The model properties region may also include author of the model, the date of the last change made to the model, an associated plan, or the like.

In one example, a user may create a new model by enter a name for the model in field 410. In field 420, the user can select an allocation method for the model. As discussed above, the allocation method determines what type of values the user will enter in the interactive matrix once the model is built. The allocation method can also determine the calculation system 100 will use when applying the model, such as to a budget, targets, or to employee allocations. In this example, the user chooses “X percent of Eligible Salaries” as the allocation method. In some embodiments, field 420 may include a drop down selection list having preconfigured allocation methods. In other embodiments, field 420 may be directly editable by the user to create custom allocation methods.

In field 430, the user can select a Public Access level. Field 430 provides who can access the model. In field 440, the user selects the allocation criteria, In this example, the user selects up to 4 criteria to structure the interactive matrix. As shown, the selected criteria are Job and Performance Rating. Field 450 may include a drop down selection list having preconfigured allocation criteria or directly allow the user to enter the allocation criteria.

Accordingly, system 100 enables users to open one or more saved, public, or global models to view, update, or apply to their budget. In one example, opening a model navigates the user to the modeling page where the selected model(s) appear on individual tabs within the page. The user can easily toggle back and forth between the models to compare them.

After choosing to open a model, system 100 may be used to display a window that displays all saved and public models that the user can access. System 100 may filter this list of models based on a plan being used. In general, saved models are those that the user created. Public models are those created by another user to which the user has been granted access. Global models are those created by a compensation administrator. The authors of public models may also be displayed.

In one embodiment, system 100 enables users to open additional models while in the modeling page. The user can once again select from a table of saved and public models. Additional models will be opened and displayed on separate tabs. The model properties region may be automatically be hidden. In another embodiment, a model created by a higher manager can be automatically filtered and display the population of employees of the viewing manager. For example, when VP creates a model, the model may include a row for “Directors.” But if a lower manager accesses that same model, it will not include a row for “Directors” since the lower manager has no workers meeting that criterion.

Referring again to FIG. 4, the user then may click control 460 to build the model and the interactive matrix. Upon building a model, system 100 may populate the bottom half of the modeling page displayed within GUI 400 with a summary table and a detail table. In some embodiments, until the user builds their model, only the model properties region of the page may be displayed. As discussed above, building the model puts the selected criteria in the proper hierarchy and lays out the table structure of the model details table based on the selected allocation method. In this interactive matrix or table, the user can enter values used in the model.

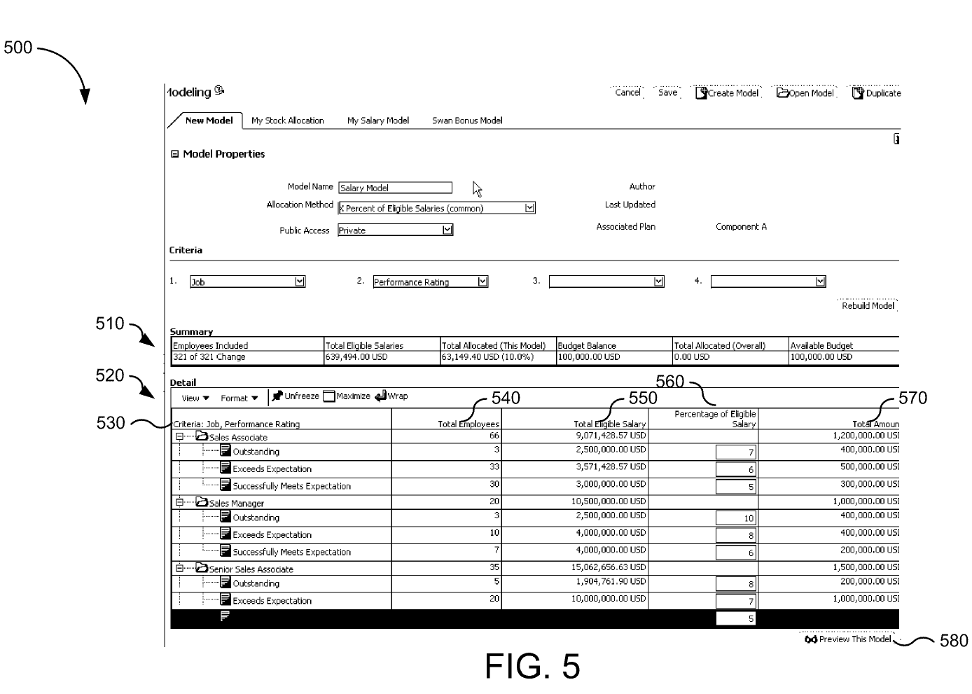

FIG. 5 is an illustration of graphical user interface (GUI) 500 displaying an interactive matrix for a model in one embodiment according to the present invention. In this example, GUI 500 includes summary section 510 and interactive matrix 520. Summary section 510 may include a summary table that provides totals of details in interactive matrix 530. Some examples of summary information may include number of employees included, total eligible salaries, available budget, used budget amount, unused budget amount, or the like.

Interactive matrix 520 can be built using allocation criteria 530 of Job and Performance Rating. In general, the selected allocation method determines the column structure of the table. The selected allocation criteria hierarchy determines the row structure.

In this example, Total Employees column 540 or interactive matrix 530 represents the number of employees who have the job/performance rating combination specified by the allocation criteria. Total Eligible Salary column 550 represents a total of the salaries of all the employees who meet that specific job/performance rating combination. In Percentage of Eligible Salary column 560, a user may enter the percentage of Eligible Salary desired to be modeled for each unique combination of Job and Performance rating. Total Amount column 570 automatically calculates based on the value entered in Percentage of Eligible Salary column 560.

By interacting with interactive matrix 520, a user can enter any value in any or all of the fields in the Percentage of Eligible Salary column. The user then can see how the values will be applied to a particular budget or target by selecting control 580 “Preview This Model.”

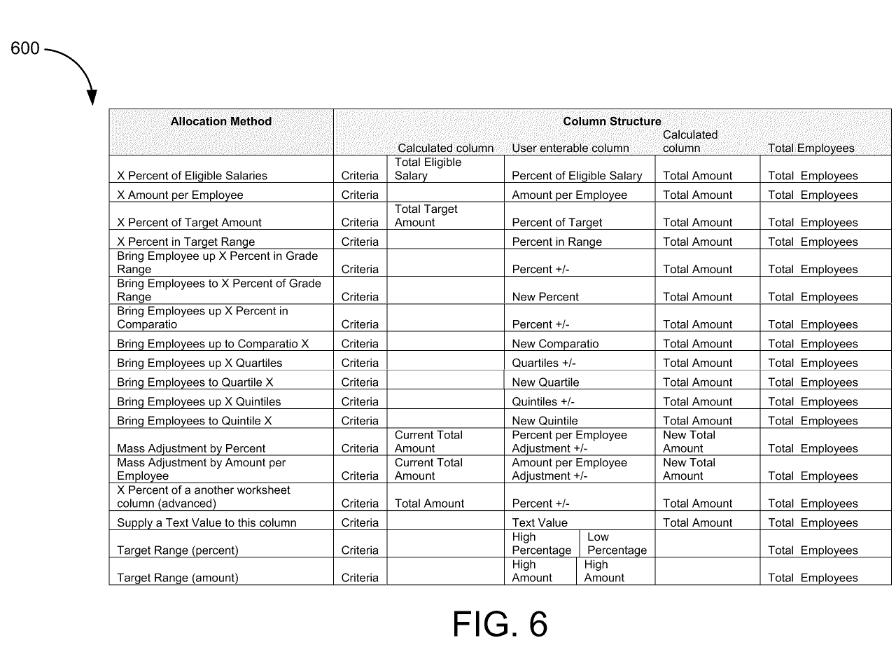

FIG. 6 is table 600 displaying structure of an interactive matrix for a model based on a selected allocation method in one embodiment according to the present invention.

In some embodiments, by default, all eligible employees are included in a model. System 100 may allow a user to uncheck one or more employees to exclude them from the model. Unselecting an employee may not change their eligibility status for a plan, but merely exclude their information from the model. After changing the employee selection, the user can then save the changes. In some example, employee selection changes are not retained for the life of the model.

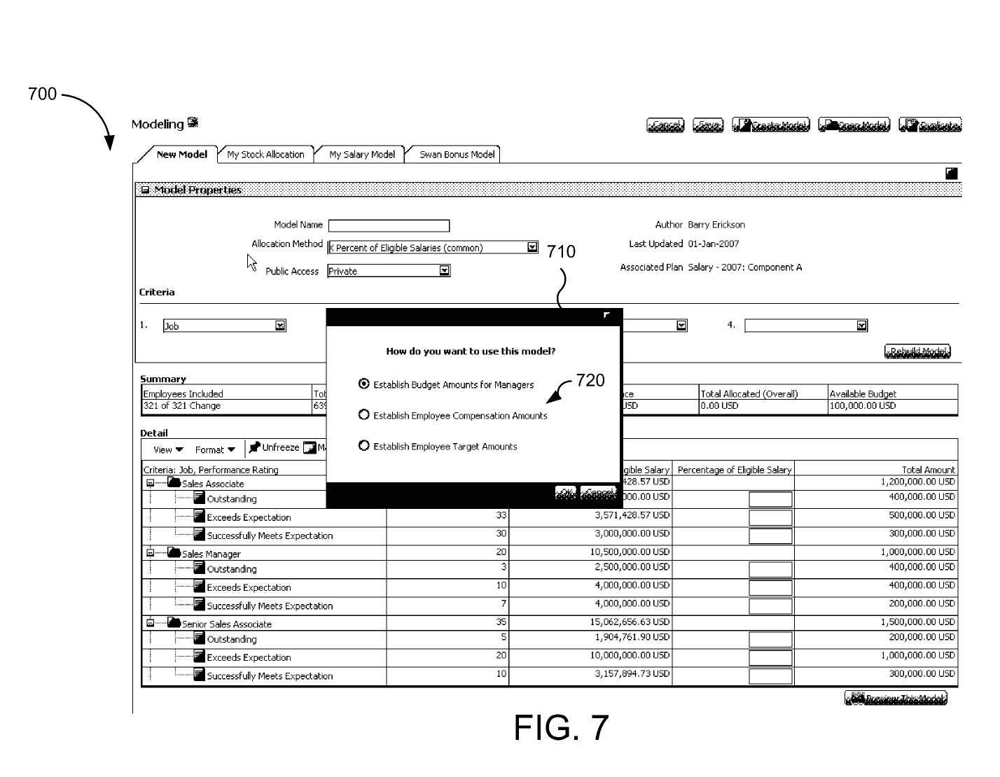

FIG. 7 is an illustration of graphical user interface (GUI) 700 for previewing a model in one embodiment according to the present invention. In this example, clicking control 580 to preview the model opens Preview Options window 710. Window 710 presents the user with one or more options 730 of how they can use the given model.

For example, options 730 may include: Establish budget amounts for managers; Establish employee compensation amounts; or Establish employee target amounts. The user may select any one of options 730 to preview the model.

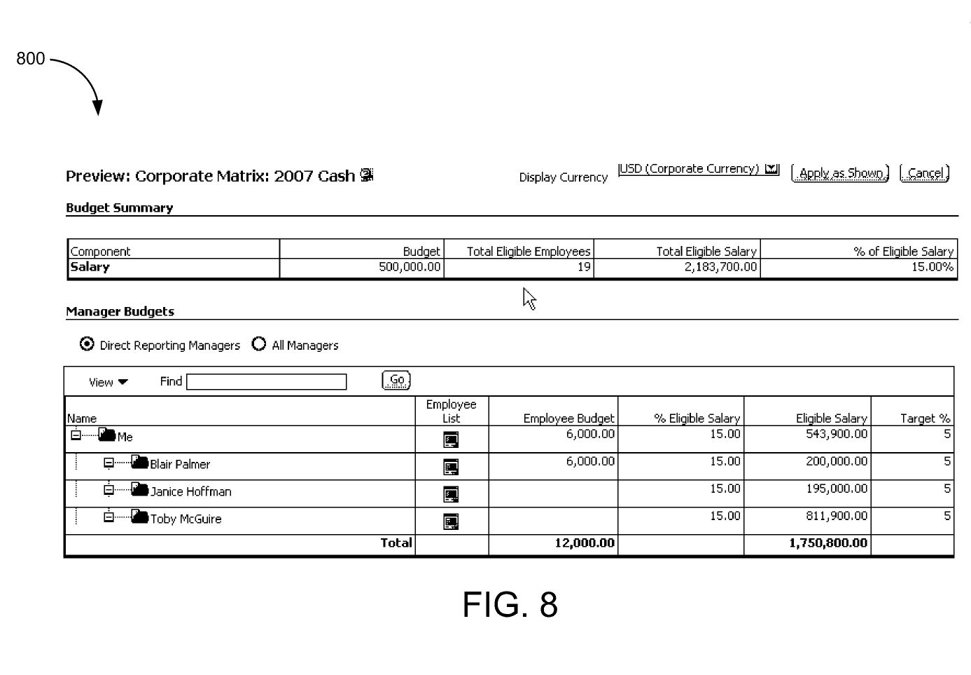

FIG. 8 is an illustration of graphical user interface (GUI) 800 displaying preview results of a model in one embodiment according to the present invention.

Assuming the user is happy with the preview results, and how the model looks, the can apply the model, or the user can return to editing the model to return to the interactive matrix and revised any values.

In various embodiments, users can apply new or existing models to a budget. After choosing to create a new model, the user can select model details, build their model, preview it, and then apply it if they are happy with the results. Users can also apply a model to budget targets. For example, a compensation manager can create a model to determine budget targets based on employee length of service and prior performance rating for a quarterly bonus plan. The compensation manager can then apply the model to the budget targets of all managers. When higher level managers are determining budget amounts for their lower level managers, they can use the budget targets as a guideline.

When previewing a model, system 100 can provide the user with the option to apply the model as budget targets. For example, applying the model as targets will populate the % Target columns in the Budget Details table. If modeling a plan that uses units rather than money, the Target Amounts column will be populated. Target amounts can be calculated and stored at the employee level. Alternatively, they can be rolled up to the manager's budget level to display targets to managers.

### Use Cases

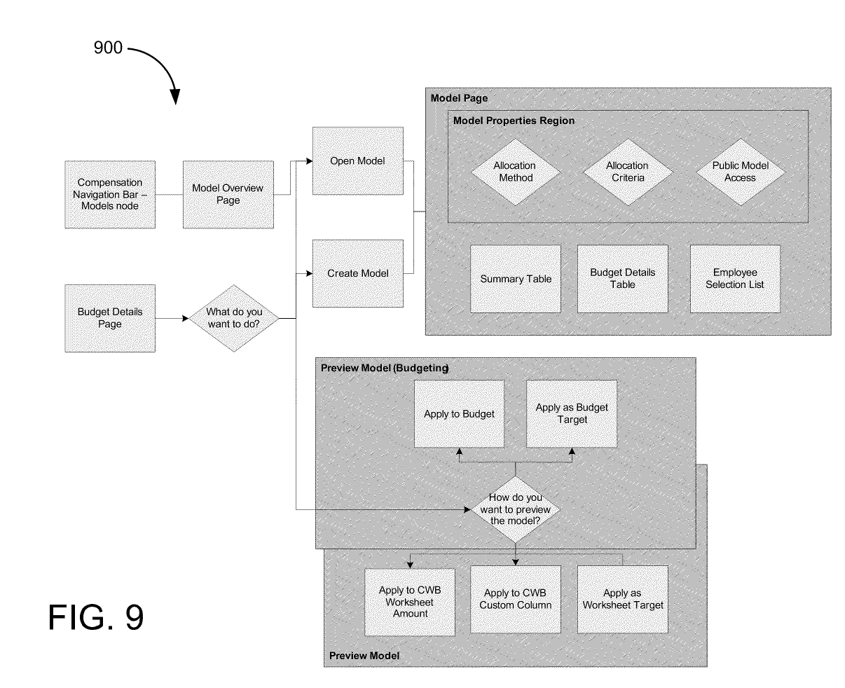

FIG. 9 is flowchart of the modeling functionality of system 100 of FIG. 1 in one embodiment according to the present invention. In one example of a user that creates a new model and applies it to his budget, a VP receives a budget that is 10% of eligible salaries for the Salary Increase Plan. He is not sure how he wants to distribute budgets for his direct reporting managers, although he feels that budgets should be based on an employee's years of service and performance rating. The VP uses the modeling functionality of system 100 to help him distribute his budget.

1. VP navigates to the budgeting UI.

2. VP selects Salary Increase Plan from Budget Overview page.

3. VP chooses Create New Model from the Model choice list on the Budget Details page.

4. VP enters “Salary Model” as the Name.

5. VP selects ‘X % of Eligible Salaries’ as the Allocation Method.

6. VP selects ‘Private’ as the Access Level.

7. VP selects ‘Years of Service’ as Allocation Criteria 1.

8. VP selects ‘Current Performance Rating’ as Allocation Criteria 2.

9. VP clicks the “Build Model” button.

10. VP enters 10% for all criteria combinations where Years of Service is >5 and Performance Rating is ‘Outstanding’. VP enters 7% for all other criteria combinations.

11. VP clicks the ‘Preview’ button.

12. VP chooses to user the model to ‘Establish Budget Amounts for Managers’.

13. VP is happy with how the model has been applied to his budget. He clicks the ‘Apply as Shown’.

14. VP returns to the Budget Details page and sees the modeled values applied to his budget.

In an alternative scenario, the VP wants to create a model to determine targets for all his lower managers. The VP uses the modeling functionality of system 100 to help him distribute his budget.

1. VP navigates to the budgeting UI.

2. VP selects the Models node from the Navigation bar.

3. VP clicks the Create New Model button.

4. VP enters “Salary Target Model” as the Name.

5. VP selects “Salary Increase Plan” as the Associated Plan.

6. VP selects ‘Target Range (percent)’ as the Allocation Method.

7. VP selects ‘Public—All’ as the Access Level.

7. VP selects ‘Years of Service’ as Allocation Criteria 1.

8. VP selects ‘Current Performance Rating’ as Allocation Criteria 2.

9. VP clicks the “Build Model” button.

10. VP enters 10 as the high percentage and 8 as the low percentage for all criteria combinations where Years of Service is >5 and Performance Rating is ‘Outstanding’. VP enters 8 as the high percentage and % as the low percentage for all other criteria combinations.

11. VP clicks the ‘Preview’ button.

12. VP chooses to user the model to ‘Establish Budget Amounts for Managers’.

13. VP is happy with how the model looks. He clicks the ‘Apply as Shown’ and sees his targets applied to his budget.

14. Now all lower managers will be able to use the same model to determine target budgets.

In yet another scenario, a company automatically issues budgets. Line managers receive budgets but do not take part in the distribution process. The compensation committee has determined that eligible employees in the development organization will receive a $10,000 bonus and employees in the operations organization will receive a $7,500 bonus. The compensation manager now needs to distribute budgets for the Quarterly Bonus plan and will use a model to help. The compensation manager uses the modeling functionality of system 100 to help him distribute his budget.

1. Compensation manager enters budgeting UI.

2. Compensation manager selects the Models node from the Navigation bar.

3. Compensation manager clicks the Create New Model button.

4. Compensation manager enters “Bonus Plan Model” as the Name.

5. Compensation manager selects “Quarterly Bonus Plan” as the Associated Plan.

6. Compensation manager selects ‘X Amount per Employee’ as the Allocation Method.

7. Compensation manager selects ‘Private’ as the Access Level.

8. Compensation manager selects Organization a criterion.

9. Compensation manager clicks the “Build Model” button.

10. Compensation manager enters $10,000 for the development org and $7,500 for the operations org.

11. Compensation manager clicks the ‘Preview’ button and selects ‘Establish Budget Amounts for Managers’.

11. Compensation manager is happy with how the budget looks and clicks the ‘Apply as Shown.

12. Compensation manager publishes the budget to all managers.

In yet another example of a user that creates a public model, a compensation manager wants to create a model for the Salary Increase Plan and make it available to all line managers so they can use it as a guideline when funding their own budgets. The company has determined that the ideal budget should be 10% of eligible salary for employees in the US and 12% of eligible salary for employees in all other countries. The compensation manager uses the modeling functionality of system 100 to help create a public model.

1. Compensation manager enters budgeting page.

2. Compensation manager selects Salary Increase Plan from Budget Overview page.

3. Compensation manager chooses Create New Model from the Model choice list on the Budget Details page.

4. Compensation manager enters “Salary Plan Model” as the Name.

5. Compensation manager selects ‘X Percent of Eligible Salaries’ as the Allocation Method.

6. Compensation manager selects ‘Global’ as the Access Level.

7. Compensation manager selects ‘Location’ as the allocation criterion.

8. Compensation manager clicks the “Build Model” button.

9. Compensation manager enters 10% for the US location and 12% for all other locations in the % of eligible salary column.

10. Compensation manager clicks the ‘Preview’ button and chooses to ‘Establish Employee Target Amounts’.

11. Compensation manager is happy with the model. She clicks the ‘Apply as Shown’ button.

12. All line managers will now have access to the Salary Plan Model when they access the modeling functionality from within the Salary Increase Plan.

In yet another example of a user that opens an existing model, a line manager needs to determine budgets for the Salary Increase Plan. He has been told that the compensation department has made available a sample model for managers to use as a guide in determining their own budgets. The company has determined targets of 10% of eligible salary for employees in the US and 12% of eligible salary for employees in all other countries. The line manager uses the modeling functionality of system 100 to help use the existing model.

1. Line manager enters budgeting page.

2. Line manager selects Salary Increase Plan from Budget Overview page.

3. Line manager chooses Open Model from the Model choice list on the Budget Details page.

4. Line manager selects to open the model called “Salary Plan Model” with the author of “Compensation Administrator”.

5. Line manager clicks the “Preview” button and chooses to use the model to ‘Establish Budget Amounts for Managers’.

6. The line manager feels that employees in the US have performed better overall than non-US employees and wants to change the budget amounts. He clicks the ‘Back’ button.

7. Line manager changes the percentages to 11% for employees in the US and 10% for all other employees.

8. Line manager clicks the “Preview” button and uses the model to ‘Establish Budget Amounts for Managers’.

9. Line manager is now happy with how his budget looks. He clicks ‘Apply as Shown’.

10. Line manager publishes his budget.

In yet another example of a user that duplicates an existing model, a compensation department has created a global model that line managers can use to help determine Salary Increase Plan budgets. The VP wants to copy that model and make a minor change.

1. VP navigates to the budgeting UI.

2. VP selects the Models node from the Navigation bar and is navigated to the Model Overview page.

3. VP clicks the “Global Model” model for the Salary Increase Plan.

4. VP clicks the duplicate icon.

5. VP enters “My Salary Model” as the New Model Name and Saves.

In yet another example of a user changing employee selection used in a model, a line manager opens an existing Quarterly Bonus Model. He knows that only 100 of his 120 employees are included in the model. He wants to include those 20 employees in the model in order for the model to take into consideration their eligible salaries.

1. Line manager enters budgeting page.

2. Line manager selects Quarterly Bonus Plan from Budget Overview page.

3. Line manager chooses Open a Model from the Model choice list on the Budget Details page.

4. Line manager selects Quarterly Bonus Plan Model and clicks the OK button.

5. Line manager clicks the “Change” link in the Summary table.

6. Line manager is navigated to the Employee Selection page.

7. Line manager checks the 20 employees who are not currently included in the model.

6. Line manager clicks ‘Save’.

7. Line manager returns to the modeling page and clicks ‘Preview’ and chooses to ‘Establish Budget Amounts for Managers’.

8. Line manager is happy with how his budget looks. He clicks the ‘Apply as Shown’ button.

9. Line manager publishes his budget.

In a still further example of a user that applies an existing model to a budget, a line manager goes to a Quarterly Bonus plan. Yesterday, he created the Quarterly Bonus model which be now wants to apply to his budget.

1. Line manager enters budgeting page.

2. Line manager selects Quarterly Bonus Plan from Budget Overview page.

3. Line manager chooses Apply a Model from the Model choice list on the Budget Details page.

4. Line manager clicks YES to the ‘Are you sure’ message.

5. Line manager clicks OK to the confirmation message.

6. Line manager looks at his budget details table and sees the model applied to his budget.

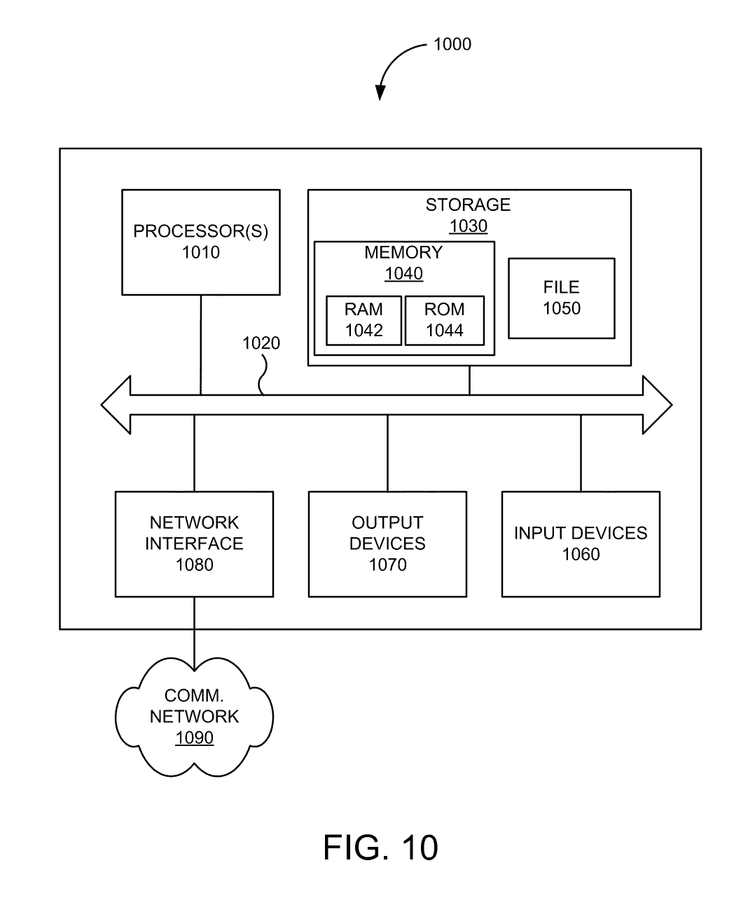

FIG. 10 is a simplified block diagram of computer system 1000 that may be used to practice embodiments of the present invention. As shown in FIG. 10, computer system 1000 includes processor 1010 that communicates with a number of peripheral devices via bus subsystem 1020. These peripheral devices may include storage subsystem 1030, comprising memory subsystem 1040 and file storage subsystem 1050, input devices 1060, output devices 1070, and network interface subsystem 1080.

Bus subsystem 1020 provides a mechanism for letting the various components and subsystems of computer system 1000 communicate with each other as intended. Although bus subsystem 1020 is shown schematically as a single bus, alternative embodiments of the bus subsystem may utilize multiple busses.

Storage subsystem 1030 may be configured to store the basic programming and data constructs that provide the functionality of the present invention. Software (code modules or instructions) that provides the functionality of the present invention may be stored in storage subsystem 1030. These software modules or instructions may be executed by processor(s) 1010. Storage subsystem 1030 may also provide a repository for storing data used in accordance with the present invention. Storage subsystem 1030 may comprise memory subsystem 1040 and file/disk storage subsystem 1050.

Memory subsystem 1040 may include a number of memories including a main random access memory (RAM) 1042 for storage of instructions and data during program execution and a read only memory (ROM) 1044 in which fixed instructions are stored. File storage subsystem 1050 provides persistent (non-volatile) storage for program and data files, and may include a hard disk drive, a floppy disk drive along with associated removable media, a Compact Disk Read Only Memory (CD-ROM) drive, a DVD, an optical drive, removable media cartridges, and other like storage media.

Input devices 1060 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to computer system 1000.

Output devices 1070 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 1000.

Network interface subsystem 1080 provides an interface to other computer systems, devices, and networks, such as communications network 1090. Network interface subsystem 1080 serves as an interface for receiving data from and transmitting data to other systems from computer system 1000. Some examples of communications network 1090 are private networks, public networks, leased lines, the Internet, Ethernet networks, token ring networks, fiber optic networks, and the like.

Computer system 1000 can be of various types including a personal computer, a portable computer, a workstation, a network computer, a mainframe, a kiosk, or any other data processing system. Due to the ever-changing nature of computers and networks, the description of computer system 1000 depicted in FIG. 10 is intended only as a specific example for purposes of illustrating the preferred embodiment of the computer system. Many other configurations having more or fewer components than the system depicted in FIG. 10 are possible.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A computer-implemented method for creating a compensation plan using a model, the method comprising:
generating a first graphical user interface with a computer system, the first graphical user interface configured to allow a user to create compensation models;
using the computer system to display the first graphical user interface on a display device;
receiving information at the computer system via the first graphical user interface enabling the computer system to create a compensation model, the compensation model having an allocation method determining the calculation to be used when the model is applied and a set of allocation criteria used to build an interactive matrix;
generating the compensation model with the computer system based on the information received via the first graphical user interface;
using the computer system to display a second graphical user interface on a display device that allows a user to interact with the matrix;
applying the compensation model to a budget or a target; and
generating information with the computer system representing of the budget or target with the applied model.

2. The method of claim 1 wherein receiving information at the computer system via the first graphical user interface enabling the computer system to create a compensation model comprises:
receiving information representing the allocation method from a selection via the first graphical user interface of a predetermined allocation method; and
receiving information representing the set of allocation criteria from a selection via the first graphical user interface of one or more predetermined allocation criteria.

3. The method of claim 1 wherein generating the compensation model with the computer system based on the information received via the first graphical user interface comprises:
obtaining information about employees that is related to the set of allocation criteria;
building the matrix with the set of allocation criteria and the information.

4. The method of claim 1 wherein generating the compensation model with the computer system based on the information received via the first graphical user interface comprises:
determining a hierarchy based on the set of allocation criteria; and
structuring the matrix using the hierarchy.

5. The method of claim 1 wherein generating the compensation model with the computer system based on the information received via the first graphical user interface comprises:
generating a third graphical user interface that enables a user to provide input for each of one or more allocation criteria in the set of allocation criteria based on the allocation method.

6. The method of claim 1 further comprising:
using the computer system to preview results of the compensation on the budget or target.

7. The method of claim 1 further comprising:
generating a second compensation model with the computer system based on using the compensation model as a model.

8. The method of claim 1 further comprising:
determining with the computer system whether a user has permission to use the compensation model.

9. A computer-implemented method for creating a model for use in compensation planning, the method comprising:
receiving first information at a computer system via a first graphical user interface enabling the computer system to create a compensation model, the first information specifying an allocation method determining the calculation to be used when the model is applied
receiving second information at the computer system via the first graphical user interface, the second information specifying a set of allocation criteria used to build an interactive matrix for a compensation model;
generating a first compensation model with the computer system based on the first information and the second information; and
storing the compensation model using a storage device associated with the computer system.

10. The method of claim 9 further comprising:
receiving third information at the computer system via a second graphical user interface, the third information specifying one or more values for allocations criteria in the set of allocation criteria; and
storing the one or more values with the compensation model.

11. The method of claim 10 further comprising:
generating preview results with the computer system representing of a preview of application of the compensation model to a budget or target based on the one or more values.

12. The method of claim 10 further comprising:
applying the compensation model to a budget or target based on the one or more values.

13. The method of claim 9 further comprising:
generating a second compensation model using the compensation model as a base.

14. The method of claim 9 further comprising:
third information at the computer system via a second graphical user interface, the third information specifying access information for the compensation model.

15. The method of claim 9 wherein the allocation method comprises at least one of a method to specify a percentage of eligible salaries, specify an amount per employee, specify a percentage of target amount, specify up to a given percentage in target range, bring employee up a given percentage in grade range, bring employees up to a given percentage of grade range, bring employees to grade minimum, bring employees up a given percentage in comparatio, bring employees up to a given comparatio, bring employees up given quartiles, bring employees up to a given quartile, bring employees up given quintiles, bring employees to a given quintile, bring employees to a percentage of market midpoint, bring employees up a percentage of market midpoint, bring employees up a percentage in market range, bring employees up a percentage of market range, specify a mass adjustment by percent, specify a mass adjustment by amount per employee, specify a target range ( by percent), or specify a target range (by amount).

16. The method of claim 9 wherein the set of allocation criteria include at least one or more of comparatio, country, grade, grade quartile, ob, compensation workbench performance rating, appraisal performance rating, department, position, years of service, direct report, flexfields, custom columns, job flexfields, quintile, grade range placement, or legal employer.

17. A system for creating a compensation plan using a model, the system comprising:
a storage device storing a database of employee information; and
a computer system communicatively coupled to the storage device, the computer system configure to generate a set of graphical user interfaces that enable a user to:
provide information that allows the computer systems to create a compensation model having an allocation method determining the calculation to be used when the model is applied and a set of allocation criteria for the employee information used to build an interactive matrix;
provide information to interact with the matrix of the compensation model;
obtain information from the computer system with respect to previewing application of the compensation model to a budget or target based on interactions with the matrix of the compensation model;
obtain information from the computer system with respect to applying the compensation model to a target or budget.

18. The system of claim 17 wherein the computer system is further configured to:
receive information representing the allocation method from a selection via one or more of the graphical user interfaces of a predetermined allocation method; and
receive information representing the set of allocation criteria from a selection via one or more of the graphical user interfaces of one or more predetermined allocation criteria.

19. The system of claim 17 wherein the computer system is further configured to:
build the matrix with the set of allocation criteria and a portion of the employee information.

20. The system of claim 17 wherein the computer system is further configured to:
determine a hierarchy based on the set of allocation criteria; and
structure the matrix using the hierarchy.

21. A computer-readable storage medium configured to store computer-executable program code for creating a compensation plan using a model, the computer-readable storage medium comprising:
code for generating a first graphical user interface, the first graphical user interface configured to allow a user to create compensation models;
code for receiving information via the first graphical user interface enabling a computer system to create a compensation model, the compensation model having an allocation method determining the calculation to be used when the model is applied and a set of allocation criteria used to build an interactive matrix;
code for generating the compensation model based on the information received via the first graphical user interface;
code for displaying a second graphical user interface on a display device that allows a user to interact with the matrix;
code for applying the compensation model to a budget or a target; and
code for generating information representing of the budget or target with the applied model.

22. The computer-readable storage medium of claim 21 wherein the code for receiving information via the first graphical user interface enabling the computer system to create a compensation model comprises:
code for receiving information representing the allocation method from a selection via the first graphical user interface of a predetermined allocation method; and
code for receiving information representing the set of allocation criteria from a selection via the first graphical user interface of one or more predetermined allocation criteria.

23. The computer-readable storage medium of claim 21 wherein the code fro generating the compensation model based on the information received via the first graphical user interface comprises:
code for obtaining information about employees that is related to the set of allocation criteria;
code for building a matrix with the set of allocation criteria and the information.

24. The computer-readable storage medium of claim 21 wherein the code for generating the compensation model based on the information received via the first graphical user interface comprises:
code for determining a hierarchy based on the set of allocation criteria; and
code for structuring the matrix using the hierarchy.

25. The computer-readable storage medium of claim 21 wherein the code for generating the compensation model based on the information received via the first graphical user interface comprises:
code for generating a third graphical user interface that enables a user to provide input for each of one or more allocation criteria in the set of allocation criteria based on the allocation method.
